(19) United States
(12) Patent Application Publication
(10) Pub. No.: US 2015/0221230 A1
(43) Pub. Date: Aug. 6, 2015

(54) Simulation Training System

(71) Applicant: Immersive Technologies, Pty. Ltd., Perth (AU)

(72) Inventors: Gregory K. Karadjian, Salt Lake City, UT (US); Richard F. Beesley, Stansbury Park, UT (US)

(21) Appl. No.: 14/605,164

(22) Filed: Jan. 26, 2015

Related U.S. Application Data
(60) Provisional application No. 61/935,236, filed on Feb. 3, 2014.

(51) Int. Cl. G09B 9/00

(52) U.S. Cl. CPC G09B 9/00

(57) ABSTRACT

A simulation training system includes a simulator housing having one or more walls and at least one display screen on at least one of the one or more walls. The system also includes one or more display devices for displaying one or more interactive simulations on the at least one display screen. The system includes one or more sensing devices arranged to track the position and/or movement of one or more trainees or parts of trainees' bodies. The system includes a motion processing module configured to process the position and/or movement data collected by the sensing devices. The simulator housing is reconfigurable between a seated configuration and a standing configuration.

### CROSS-REFERENCE TO RELATED APPLICATIONS

The present application claims priority to and the benefit of U.S. Provisional Patent Application No. 61/935,236 entitled “SIMULATION TRAINING SYSTEM” filed Feb. 3, 2014, which is incorporated herein by reference.

### BACKGROUND

Traditional training methods (e.g., the use of instructional videos, training sessions, demonstrations, and apprenticeships) are often inadequate for miner training. Trainers have investigated different technologies and strategies for improving a miner's training experience. One strategy is to use virtual reality and virtual environments. For example, a number of simulators have been made commercially available for miner training. These simulators train workers to operate equipment, such as haul trucks and bulldozers, by using a cockpit setup with real controls and interacting with a screen displaying a virtual world. While such simulators can provide an improved level of realism not possible in the classroom, as well as reduced cost compared to real-world exercises, they also tend to suffer from a number of drawbacks.

For example, such simulators are typically specialized for the training of workers in only a single operational setup (e.g., operation of heavy equipment) or in relation to a specific environment. Thus, a trainer or company may be required to purchase and use a number of different simulators to train personnel in different operational setups. This can be expensive and inconvenient and can also require a significant amount of space. In addition, such simulators can be difficult to transport between sites. Further, components of such simulators are typically nonstandard and/or not multifunctional such that these simulators are truly limited use simulators.

In addition, conventional simulators train users in a particular and fixed setting, such as the driver's seat of heavy machinery. The simulator necessarily makes approximations as to the user's location or perspective. This results in a “one-size-fits-all” design that does not allow for natural movement of the operator within the simulation environment.

Accordingly, users and manufacturers of simulation training systems continue to seek simulation training systems that are more realistic, versatile, modular, and transportable to provide more effective training and reduce the number of mining accidents.

### SUMMARY

One or more embodiments of the present disclosure include a simulation training system that is modular, portable, versatile, and provides a more effective training experience. In particular, some embodiments of the present disclosure include a simulation training system including a simulator housing having one or more walls, and at least one display screen on at least one of the one or more walls. The system also includes one or more display devices for displaying one or more interactive simulations on the at least one display screen. Some embodiments include one or more sensing devices that may track the location or orientation of one or more parts of at least one user's body and a motion processing module that can process position or orientation data associated with the one or more parts of the at least one person and that is obtained from the one or more sensing devices.

In other embodiments, a simulator housing is reconfigurable between a seated configuration, wherein a seating platform having a seat and seated controls is positioned within the simulator housing such that at least one person may sit in the seat and interact with the one or more interactive simulations, and a standing configuration, wherein the seating platform is removed from the simulator housing such that the at least one person can stand and/or freely move within the simulator housing and interact with the one or more interactive simulations.

In an embodiment of a method described herein, an interactive simulation is updated by receiving one or more commands and moving a virtual representation of a user within an interactive simulation. At least partially based on the one or more commands, moving the virtual representation of the user changes between a micro-movement mode and a macro-movement mode. The micro-movement mode includes updating a position of the virtual representation of the user within the simulation to substantially match the position of the user within a simulator housing. The macro-movement mode includes updating a position of the virtual representation of the user within the interactive simulation to substantially match movement of the user in accordance with one or more movement schemes.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 depicts a cutaway isometric view of a simulation training system in a seated configuration according to an embodiment;

FIG. 2 depicts a cutaway isometric view of the simulation training system shown in FIG. 1 in a standing configuration according to an embodiment;

FIG. 3 depicts a cutaway isometric view of a simulator housing showing the detection of an operator according to an embodiment;

FIG. 4 illustrates exemplary steps of method for moving between a micro-movement mode and a macro-movement mode according to an embodiment;

FIG. 5 illustrates a flowchart for dynamically adjusting a rate of movement based on a contextual change;

FIG. 6 illustrates a computing system according to an embodiment;

FIG. 7 depicts a cutaway isometric view of a simulation training system according to another embodiment;

FIG. 8 depicts a cutaway isometric view of a simulation training system including a removable cart according to another embodiment;

FIG. 9 depicts a detail view of a simulator housing floor including a platform hole and removable cover according to an embodiment;

FIG. 10 depicts a simulation training system with a curved display in a freestanding configuration according to an embodiment;

FIG. 11 depicts a head-mounted display of a simulation training system according to an embodiment; and

FIG. 12 depicts a cutaway isometric view of a plurality of sensors within a simulation training system detecting an operator wearing a head-mounted display.

### DETAILED DESCRIPTION

Reference will now be made to the exemplary embodiments illustrated in the figures, wherein like structures will be provided with like references. Specific language will be used herein to describe the exemplary embodiments, nevertheless it will be understood that no limitation of the scope of the disclosure is thereby intended. It is also to be understood that the drawings are diagrammatic and schematic representations of various embodiments of the disclosure, and are not to be construed as limiting the present disclosure. Alterations and further modifications of the features illustrated herein, and additional applications of the principles of the disclosure as illustrated herein are to be considered within the scope of the disclosure. Furthermore, various well-known aspects of simulators are not described herein in detail in order to avoid obscuring aspects of the example embodiments.

In describing the present disclosure, the term “trainee” can refer to an individual and/or a plurality of individuals within a simulated area or environment described below. Such individuals may include miners, emergency responders, workers, personnel, bystanders, inspectors, operators, students, government officials, adults, children, rescue animals, work animals, any other user, and/or combinations thereof. Similarly, the term “trainer” can refer to an individual and/or a plurality of individuals. The trainer and trainee may be the same individual and/or different individuals.

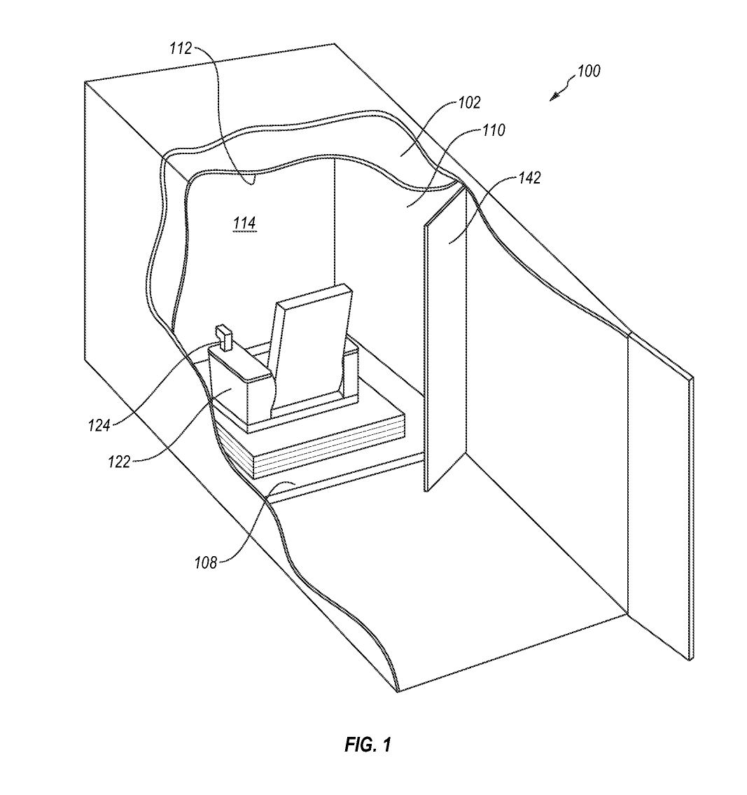

Illustrated in, and described relative to FIGS. 1 through 12, are various exemplary embodiments of a simulation training system. The simulation training system of the present disclosure can be used to provide enhanced mining equipment simulation training. For example, a simulation training system of the present disclosure can be used to train mining personnel in at least two different simulation setups, using a single system. More particularly, the simulation training system of the present disclosure can be reconfigurable between a first configuration or setup for training persons to operate machinery operated from a seated position (herein referred to as a “seated setup”) and a second configuration or setup for training a person standing position or a person walking, crawling or in other forms of natural movement (herein referred to as “standing setup”). In addition to being reconfigurable between different training setups, the simulation training system of the present disclosure is modular so that, although different training setups may include different features, many components of the different setups may be shared between them. Accordingly, the simulation training system of the present disclosure can be used for various types of simulation setups.

Moreover, the simulation training system of the present disclosure may further be capable of moving a simulation between a micro-movement mode, in which the position of a virtual representation of the trainee within the simulation or simulated environment is updated to substantially match the real position of the trainee within a simulator housing of the system, and a macro-movement mode, in which the position of the virtual representation of the trainee is updated within the simulated environment to match movement of the trainee in accordance with one or more movement schemes.

It will be appreciated that while the illustrated system can be used to train mining personnel, the present disclosure may also have application in other environments such as, for example, construction training, military training, medical training, gaming, and/or other appropriate environments.

FIG. 1 illustrates a simulation training system 100 according to an embodiment. The system 100 can include a simulator housing 102 in which an operator may train. The simulator housing 102 can include a floor 108, a plurality of walls 110, and a ceiling 112 that at least in part define a training space. One or more doors 142 can be fitted to the simulator housing 102 to allow ingress and egress from the training space while allowing the training space to remain enclosed during use.

The simulator housing 102 may include various features to facilitate the use of multiple configurations of the system 100. For example, the simulator housing 102 as depicted in FIG. 1 includes a seat 122 and seated controls 124 that may replicate an operating configuration the same as or similar to a seated configuration in a vehicle, heavy machinery, factory setting, or other seated control configuration. As discussed in more detail below, the seat 122 and seated controls 124 can be movable and/or removable to enable reconfiguration of the system 100. The simulator housing 102 may include a display screen 114 that is located on at least one of the walls 110. In an embodiment, the display screen 114 may comprise one or more of the walls 110, a projection screen adjacent one or more of the walls 110, one or more electronic displays such as LCD, CRT, Plasma, or other types of monitors or display surfaces adjacent one or more of the walls 110. In other embodiments, at least part of the display screen 114 may comprise the ceiling 112 and/or floor 108 and/or may be mounted adjacent the ceiling 112 and/or floor 108.

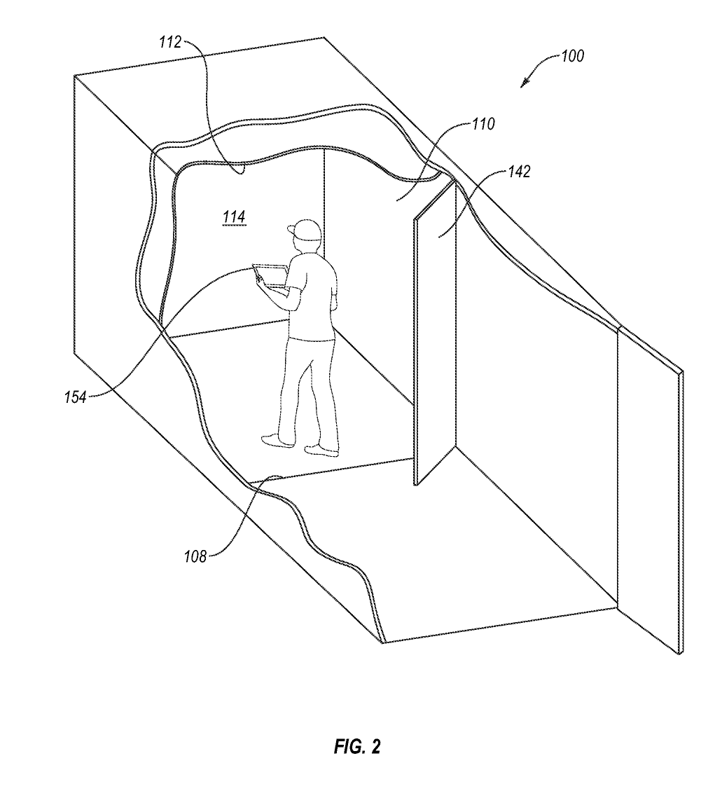

The system 100 can be reconfigurable between a seated configuration (e.g., the configuration shown in FIG. 1) and a standing configuration (e.g., the configuration shown in FIG. 2). As such, the system 100 can be operated to train mining personnel in at least two different simulation setups, thereby significantly increasing the versatility of the system 100. Referring now to FIG. 2, in the standing configuration the seat 122 and seated controls 124 can be removed from the simulator housing 102, allowing a trainee to move substantially free within the simulator housing 102. The system 100 may include hand-held controls 154 that can be manipulated by the trainee while moving about the simulator housing 102. In an embodiment, the one or more walls 110 may be configured so at to create a simulation area or simulation environment large enough to accommodate one or more individuals. The doors 142 can be removable to replicate an enclosed environment or an open environment.

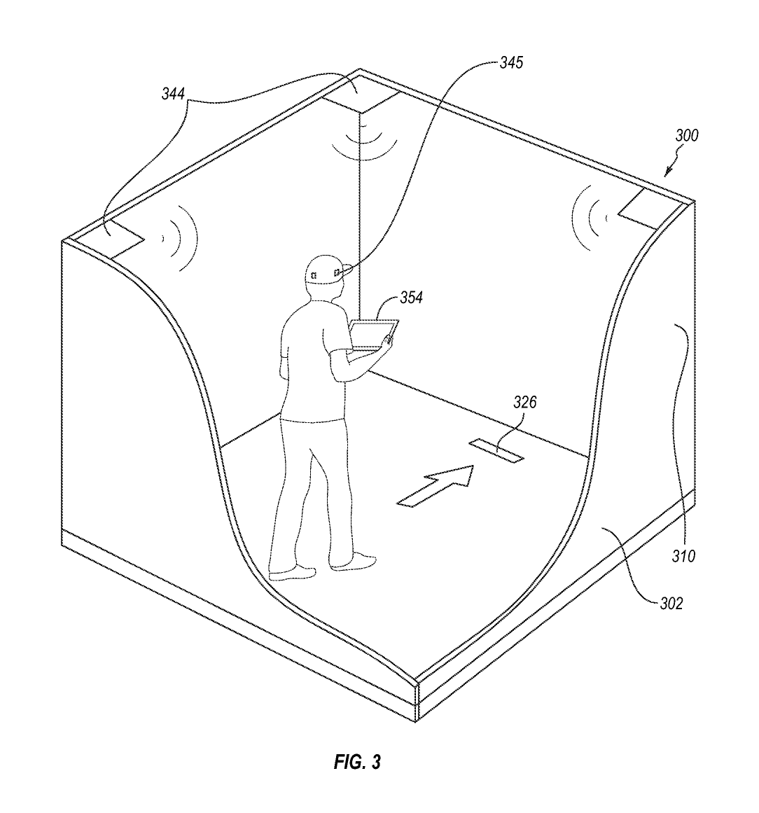

FIG. 3 shows a simulation system 300 and the detection and tracking of a trainee within a simulator housing 302 of the system 300 in a standing configuration. While FIG. 3 depicts a standing configuration, it should be understood that the detection and tracking of a trainee can be used in a seated configuration to identify a position and/or movements of the trainee while seated. The system 300 can include one or more sensing devices 344 for sensing position and/or orientation of at least one person, or multiple specific body part movements within or near the simulator housing 302. The sensing devices 344 may include camera(s) (infrared or otherwise) and associated markers, accelerometers, pressure sensors, laser sensors, user controlled input devices, motion sensors, combinations thereof, of any other suitable sensing device. In an embodiment, the at least one sensing device 344 may be further configured to record an individual's activities during a simulation. The sensing devices 344 may be located in any suitable location for providing accurate motion tracking throughout a specific area or range of movement. For example, sensing devices 344 comprising cameras may be located upon the ceiling. In an embodiment, one sensing device 344 may be located at each corner of the ceiling adjacent a wall 310, and one or more near or at the middle of each wall 310 of the simulator housing 302. If the simulator housing 302 includes a component that would otherwise obstruct the sensing devices 344, the sensing devices 344 may be installed hanging from the ceiling so that the component (e.g., an air conditioning unit) does not obstruct their view. One or more of the sensing devices 344 may comprise one or more video cameras configured to record a trainee's activity during a simulation. In some embodiments, the simulator housing 302 can have a panel display configuration. Such a configuration may be effective for simulations where people require limited visibility within the simulated environment or area.

As noted above, the system can be reconfigurable between a seated configuration and a standing configuration. In the seated configuration, the system 300 can use sensing devices the same as or similar to the sensing devices 344 in FIG. 3 to help track and obtain location and orientation data for the trainee, the trainee's head, hands, or other significant body part within the simulated area and/or environment. For example, the sensing devices 344 can comprise one or more cameras that can detect head movement by emitting infra-red light that reflects off of passive markers 345 (e.g., retro-reflective balls or the like) attached to the head of the trainee. In another embodiment, the sensing devices 344 can comprise one or more cameras that can detect head movement by receiving a signal that originates from active markers (e.g., infra-red light emitting diodes [LEDs], radio frequency identification [“RFID”] nodes, or the like) attached to the head of the trainee.

Using such position/orientation data, the system 300 can provide a more realistic simulation experience updating/adjusting simulated imagery displayed on the at least one display screen as the trainee's head moves. For example, in a seated configuration and/or a standing configuration, the system 300 may utilize position and/or orientation data for the trainee's head to update the simulated imagery (e.g., update a viewing frustum of the simulated imagery), reflecting changes in visibility that would be observed in a real-world application. When the trainee's head is in a normal position, the simulated imagery may be such that a virtual object is hidden. As the trainee leans or moves forward, position and/or orientation data associated with movement of the trainee's head can enable the system 300 to adjust or update the imagery such that the virtual object is revealed to the trainee. As the position of the trainee's head moves further forward, the updated position and/or orientation data associated with the trainee's head can enable the system 300 to further adjust or update the imagery such that more of the virtual object is revealed to the trainee. Accordingly, a trainee can look around posts and can see hidden hazards and other external objects as their perspective changes as it does in a real machine. In addition, data on the head position and/or orientation may also be assessed against the situation within the simulated environment and operational procedures for the purposes of assessing operation technique (e.g., checking blind spots by looking to the side prior to turning) and/or detecting contextual commands. Such a configuration can be helpful and/or used in both the seated configuration and the standing configuration.

Where a trainee is wearing headwear including a connection mechanism for a light source (e.g., a miner's helmet), one or more of the markers 345 can be attached to the helmet using the same connection mechanism. In other embodiments, the one or more markers can be attached to a helmet or other headwear via friction, clamps, magnets, or any other suitable connection means. In yet other embodiments, the one or more markers may be incorporated into headwear such as a baseball cap or cowboy hat. Where markers are desired to be used with multiple people within a simulation, a plurality of marker patterns may be employed. For example, each individual may include a marker that is unique geometrically (e.g., marker shape) or has a unique frequency. For example, each marker may have a unique pulsing frequency or the markers may include one or more passive markers. In other embodiments, where reflective markers are impracticable (e.g., trainee is wearing reflective safety clothing), the system 300 may utilize infra-red LED markers or any other suitable marker to help limit sensor interference.

In the standing configuration, the system 300 may include one or more hand-held controls 354 that a trainee can operate and/or view within a simulation. The hand-held controls 354 may transmit data to and/or receive data from a simulation, allowing the trainee to use the hand-held controls to send commands to the simulation (e.g., close a valve) and/or view information (e.g., simulated hazardous gas levels). The hand-held controls 354 can interact with an input module described below. As such, the trainee can simulate operating machinery typically operated by a person walking or standing within the simulation. Such machinery may include, for example, but is not limited to, compactors, hydraulic drilling systems, rovers, or the like. In other embodiments, the simulation training may include the trainee operating equipment via remote control. In an embodiment, the one or more hand-held controls 354 may be connected to the system 300 via cables or connectors connectable to a connection panel 326. In other embodiments, the one or more hand-held controls 354 may communicate wirelessly with the system 300. In yet other embodiments, the one or more hand-held controls 354 may be connected to the system 300 via cables or connectors fed through the simulator housing to an exterior of the simulation housing. For instance, the one or more hand-held controls may be operatively connected to the system 300 via cables or connectors extending through one or more apertures defined in at least one wall of the simulator housing 302. The aperture can include bristles arranged to allow the cables or connectors to pass through the aperture while at the same time substantially preventing light from entering the simulator housing 302 via the aperture. As such, the system 300 is modular so that many of the components of the different setups may be shared between them.

Like in the seated configuration, the system 300 in the standing configuration can track and obtain location and orientation data for the trainee, the trainee's head, hands, or other significant body part within the simulated area and/or environment. For example, the system 300 may collect and/or use data associated with the user's position and/or orientation to update the simulated imagery to reflect changes in visibility that would be observed in a real-world application. In other embodiments, data and/or information associated with the trainee may also be assessed against a situation within the simulated environment and operational procedures for the purposes of assessing operation technique (e.g., stepping into, or placing a hand into a dangerous location). For example, data and/or information associated with the trainee may be accessed by a grading module (described below) of the system 300 against a situation within the simulated environment for assessment or grading purposes.

It should also be understood that sensing devices 344 may be used to monitor the movement and/or gestures of a trainee without additional controls such as hand-held controls 354 and/or seated controls 124 (shown in FIG. 1). A simulation may include a trainee moving within and/or interacting with an emergency situation without the aid of communication with equipment or audible communication with other individuals. In such a simulation, the trainee may be limited to movement within the simulated environment and gestures to communicate. In an embodiment, a trainee may use gestures to interact with one or more elements of the simulation. For example, a trainee may use a gesture to interact with a simulated fire extinguisher during a simulated emergency situation without additional controls. It will further be appreciated that the hand-held controls and/or seated controls can be physical controls and/or simulated controls.

The system 300 may also be configured to move a simulation between a micro-movement mode, in which the position of a virtual representation of the trainee with the simulation or simulated environment is updated to substantially match the real position of the trainee within the simulator housing 302, and a macro-movement mode, in which the position of the virtual representation of the trainee is updated within the simulated environment to match movement of the trainee in accordance with one or more movement schemes. The one or more movement schemes may be selected by a user or the trainee. The one or more movement schemes may be generated by the system 300.

Transition between the micro-movement mode and the macro-movement mode by occur in response to receiving one or more commands. Such commands may comprise user initiated input received by the system 300. For example, the system 300 may move between the micro-movement mode and the macro-movement mode in response to receiving a command in the form of the trainee depressing a specific key, or key combination on a hand-held device or control 354. The system 300 may move between the micro-movement mode and the macro-movement mode in response to receiving one or more commands in the form of the trainee performing a set gesture such as, for example, the trainee raising their hand to their head or any other suitable user initiated input. Thus, the trainee can toggle between the movement modes. The system may move between the micro-movement mode and the macro-movement mode response to receiving one or more commands in the form of directions automatically generated by the system 300. For example, the system 300 may move between the micro-movement mode and the macro-movement mode automatically based on the context of the simulated environment and/or required task. In such an example, the system 300 may automatically recognize macro-movement commands and micro-movement commands independently. The system 300 may automatically recognize macro-movement commands from a joystick on the hand-held controls 354 and/or seated controls (e.g., seated controls 124 in FIG. 1) and micro-movement commands from movements of the trainee and/or markers 345 sensed by sensing devices 344 within the simulator housing 302.

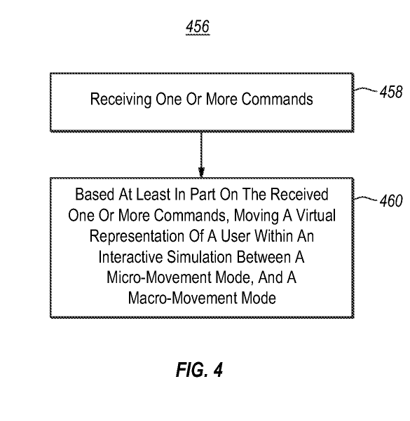

FIG. 4 illustrates exemplary steps in a method 456 for updating a simulation using any of the systems as described herein. It will be appreciated that not all of the depicted steps have to occur in the order shown, as will be apparent to persons skilled in the relevant art(s) based on the teachings herein. Other operational and structural embodiments will be apparent to persons skilled in the relevant art(s) based on the following direction. In act 458, one or more commands (e.g., instructions, data, signals, commands, etc.) are received. As discussed above, the one or more commands may be user initiated and/or automatically generated by the system. In act 460, based at least in part on receiving the one or more commands, the virtual representation of a trainee within an interactive simulation is moved between a micro-movement mode in which the position of the virtual representation of the trainee within the simulation is updated to substantially match the position of the trainee within a simulator housing, and a macro-movement mode in which the position of the virtual representation of the trainee is updated within the simulated environment to match movement of the trainee in accordance with one or more movement schemes. In an embodiment, a movement scheme may include directing and/or controlling movement of the simulation and/or the virtual representation of the trainee within the simulation using a joystick or another suitable device. For example, in an embodiment, a trainer may control the simulation using a joystick at a trainer station as will be described in more detail below.

A movement scheme can include the further the trainee walks away from an origin, the faster the rate of movement of the virtual representation of the trainee within the simulation. Such a configuration may help a trainee reach a desired virtual location within the simulation (e.g., a specific machine or geo-spatial location) in a shorter amount of time. Further, such a configuration may allow a trainee to be virtually transported within an interactive simulation as desired by the trainee and/or a trainer. In addition, such a configuration may allow a trainee to bypass one or more situations within a simulation.

A movement scheme can include setting an origin of movement at a position where a first command or user input was received by the system. A movement scheme may also include determining a directional vector for the movement in response to receiving a second command or user input. For example, if a trainee looks in a first direction, the directional vector for the trainee's movement can be set in the same first direction. A movement scheme may further include moving back to the micro-movement mode in response to receiving a third command or user input. For example, if the trainee steps backwards or repeats a toggle command, the system can revert to the micro-movement mode.

A movement scheme may include setting a center of a simulator housing such as simulator housing 302 in FIG. 3 as an origin of the movement scheme. Optionally, a dead band or space may exist at the origin to help prevent unintentional movement. The further the trainee moves form the origin and/or the dead band, the faster the rate of movement. A movement scheme may also include determining a directional vector for the movement in response to receiving a second command or user input. For example, if the trainee steps in a first direction, the directional vector of movement for the trainee's movement in the simulation may be set in the same first direction. A movement scheme may further include moving back to the micro-movement mode in response to receiving a third command or user input. In an embodiment, if the trainee steps backwards, claps, or repeats a toggle command, the system can revert to the micro-movement mode. It will be understood that the above movement schemes are exemplary only and any number of movement schemes are possible. For example, other movement schemes may include flying through a simulated environment, moving through simulated objects (e.g., to better understand how a piece of machinery works), moving slower through a simulated environment, changing the perspective of the simulation, or any other suitable movement scheme.

By way of another example, a movement scheme may include dynamically adjusting and/or slowing motion in the macro-movement mode as a trainee approaches and/or gets closer to a specific virtual object and/or location, such as, for example, an item that needs to be inspected, a hazard, an area of interest, or the like.

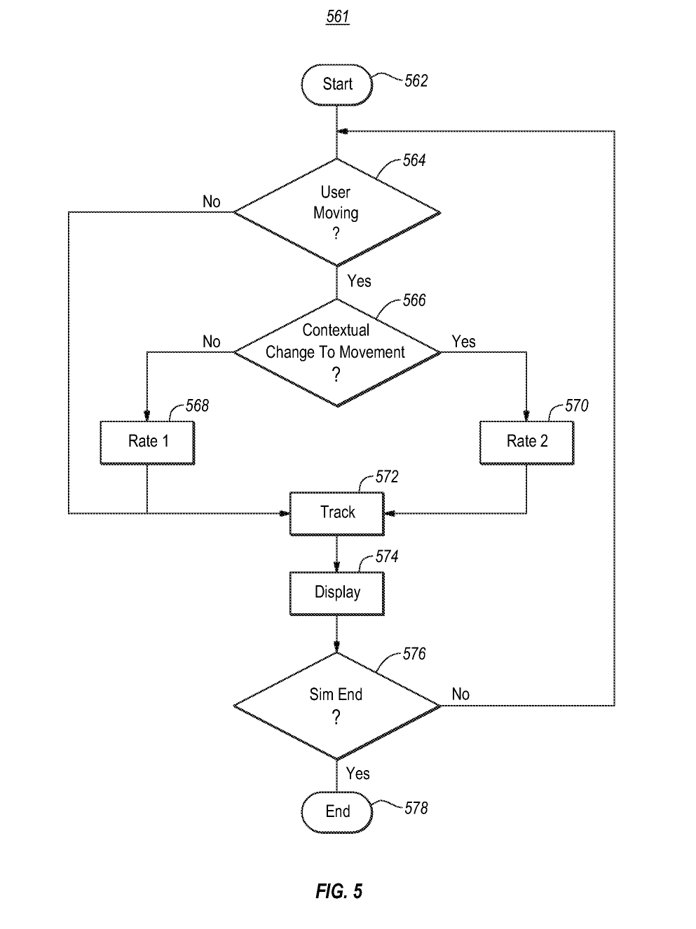

In an embodiment, the system can include a contextual speed limit. For example, FIG. 5 illustrates an example flowchart 561 for dynamically adjusting a rate of movement based on a contextual change. As depicted in FIG. 5, the flowchart begins at block 562, and then immediately proceeds to block 564, where it is determined whether a user is moving. If the user is not moving (‘No’ in block 564), the flowchart proceeds to block 572, where the user's motion (or lack thereof) is tracked (at block 572) and displayed (at block 574). The process then either repeats or ends (based on block 576). If the user is moving, however, (‘Yes’ in block 564) it is determined in block 566 if there has been a contextual change to movement. For example, it may be determined if the user is moving faster or slower, if the user has provided gesture or other input indicating a desired context change, if the user has approached a simulated location that warrants a context change, etc.

If there has not been a contextual change to movement (‘No’ in block 566), a first movement rate 568, such as a default movement rate, is selected and the user's motion is tracked at block 572 using the first rate 568 and displayed at block 574 (and then the process either repeats or ends based on block 576). Alternatively, if there has been a contextual change to movement (‘Yes’ in block 566), a second movement rate 570, such as a rate that is faster than rate 568 or slower than rate 568, is selected. The user's motion is then tracked at block 572 and displayed at block 574, and the process either repeats or ends (based on blocks 576, 578). For example, if at block 566 it is determined that the user has reached a point of interest, rate 570 (which is slower than rate 568) may be selected to the user can investigate the point of interest in additional detail. In some embodiments, during the macro-movement mode, the default rate of movement can be relatively high, and the rate of movement in certain contexts (e.g., standing right next to a machine) can be relatively slow. To help transition between different rates of movement, a system according to the present disclosure may interpolate between the different speeds so that the effect of moving from one speed to the other is not sudden and/or jarring. It will be appreciated that the functionality of the exemplary embodiments of the system in the standing configuration may be employed with the exemplary embodiments of the system in the seated configuration, and vice versa.

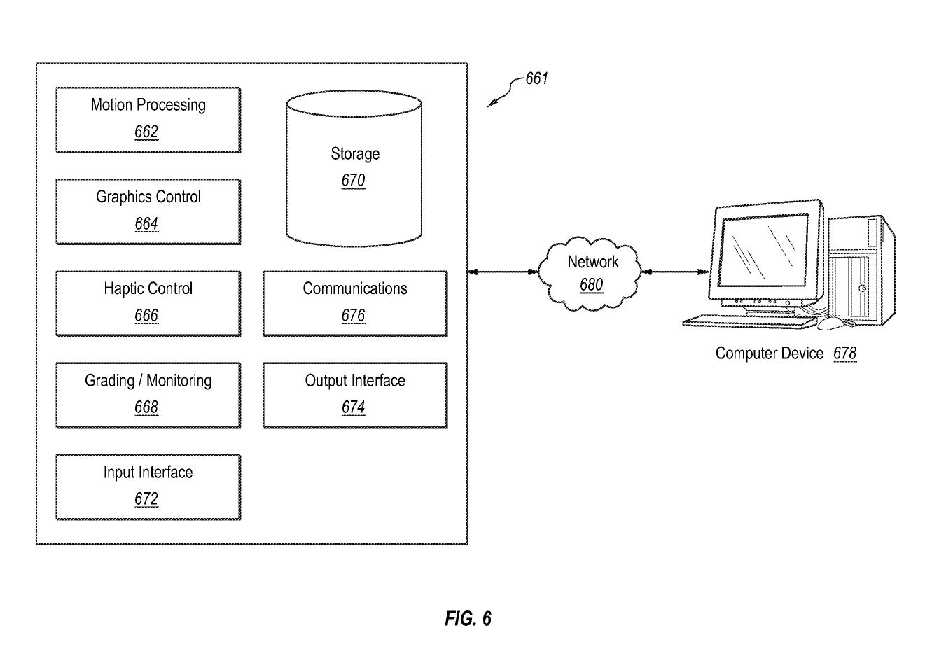

FIG. 6 illustrates a computing system 661 (and associated peripherals) that can control and/or permit the overall administration of the system according to an embodiment. The computing system 661 can be a distributed system including components of the computing system 661 distributed in one or more computing devices. The computing system 661 can include one or more components of the computing system 661 in a single computing device. The computing system 661 can include a motion processing module 662, a graphics control module 664, a haptic control module 666, a grading module 668, a storage device 670, an input interface module 672, an output interface module 674, and a communications module 676. The motion processing module 662 can be configured to interpret and/or process information and/or signals received from one or more sensing devices described herein and/or the input interface module 672. The graphics control module 664 can be configured to generate simulated imagery and/or to adjust or update simulated imagery based on information received from the motion processing module 662, the storage component 670, and/or the input interface module 672. The graphics control module 664 can receive information (e.g., one or more commands, user input, instructions, motion data, orientation data, or the like) from the motion processing module 662, the storage component 670, and/or the input interface module 672. Based on the received information, the graphics control module 664 can be configured to dynamically adjust the motion of the virtual representation of the trainee within the simulation such that the trainee's virtual movement within the simulation is faster and/or slower in relation to one or more objects. For example, it may determine if the user is moving faster or slower, if the user has provided a gesture or other input indicating a desired context change, if the user has approached a simulated location that warrants a context change, etc.

In addition, the graphics control module 664 can be configured to cause the simulated imagery to be displayed on the one or more display screens and/or to display a video or a virtual representation of the trainee within the simulation based on information received from the one or more sensing devices and/or the motion processing module 662. The haptic control module 666 can be configured to generate and/or provide haptic feedback to a user. For example, the haptic control module 666 can be configured to enable the computing system 661 to provide haptic feedback to one or more individuals (e.g., a trainee) based on data or information received from the motion processing module 662, the input interface module 672, and/or the graphics control module 664. The grading module 668 can be configured to analyze, monitor, and/or report trainee/user performance based in part on information received from the motion processing module 662 and/or the storage device 670.

The storage device 670 is configured to store data for use by the system, and can comprise any number of interconnected or separate storage components. For example, the storage device 670 can store an application, simulation software, trainee and session information, operational procedures, trainee information, course information, grading information, simulation models, and/or any other relevant information. The storage device 670 may be incorporated into or may peripheral to the computing system 661 and to allow the computing system 661 to retain large amounts of data.

Input interface module 672 can be configured to enable the computing system 661 to receive data and/or instructions through one or more input components. Such input components may include seated controls, hand-held controls, overhead controls, keyboards, a mouse, a microphone, a joystick, a scanner, and/or any other suitable input device. For example, such input components can include the sensing devices. A particular input component may be integrated with or peripheral to the computing system 661. In addition, input interface module 672 can be configured to generate one or more user interfaces that enable user interactivity with one or more modules or components of the system. Moreover, input interface module 672 can comprise any number of interconnected or separate components.

Output interface module 674 can be configured to enable one or more components or modules of the computing system 661 to output data and/or information through one or more output components. Examples of output components can include one or more display screens, seating platforms, user controls (e.g., seated controls), a speaker, a printer, or the like. A particular output component may be integrated with or peripheral to the computing system 661. In an embodiment, the haptic module 666 may comprise the output interface module 674.

Communications module 676 can enable the computing system 661 to exchange information with one or more other local or remote computer devices, illustrated as a computer device 678, via a network 680, such as for example, a Local Area Network (“LAN”), a Wide Area Network (“WAN”), and even the internet. Accordingly, each of the depicted computer systems as well as any other connected computer systems and their components, can create message related data and exchange message related data (e.g., Internet Protocol [“IP”] datagrams and other higher layer protocols that utilize IP datagrams, such as, Transmission Control Protocol [“TCP”], Hypertext Transfer Protocol [“HTTP”], Simple Mail Transfer Protocol [“SMTP”], etc.) over the network. For example, the communication module 676 can be configured to enable sending and/or receiving of simulation information and/or reports to a trainer's computer device 678. In addition, communication module 676 can be used in connection with the other modules/components of the computing system 661 and can comprise any number of interconnected or separate components. It will be appreciated that any of the functions, methods, and/or operations disclosed herein may implemented in simulation software or an application executed on the computing system 661.

It should be understood that many of the elements described in the disclosed embodiments may also be implemented as modules. A “module” is defined here as an isolatable element that performs a defined function and has a defined interface to other elements. The modules described in this disclosure may be implemented in hardware, a combination of hardware and software, firmware, or a combination, all of which can be behaviorally equivalent. Modules may be implemented using computer hardware in combination with software routine(s) written in a computer language. It may be possible to implement modules using physical hardware that incorporates discrete or programmable analog and/or digital hardware. Examples of programmable hardware include computers, microcontrollers, microprocessors, application-specific integrated circuits, field programmable gate arrays, and complex programmable logic devices.

The application may be software embodied on a computer readable medium which when executed by a processor component of a computer device performs a sequence of steps. Moreover, embodiments of the present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources include processing capacity, memory, disk space, network bandwidth, media drives, and so forth.

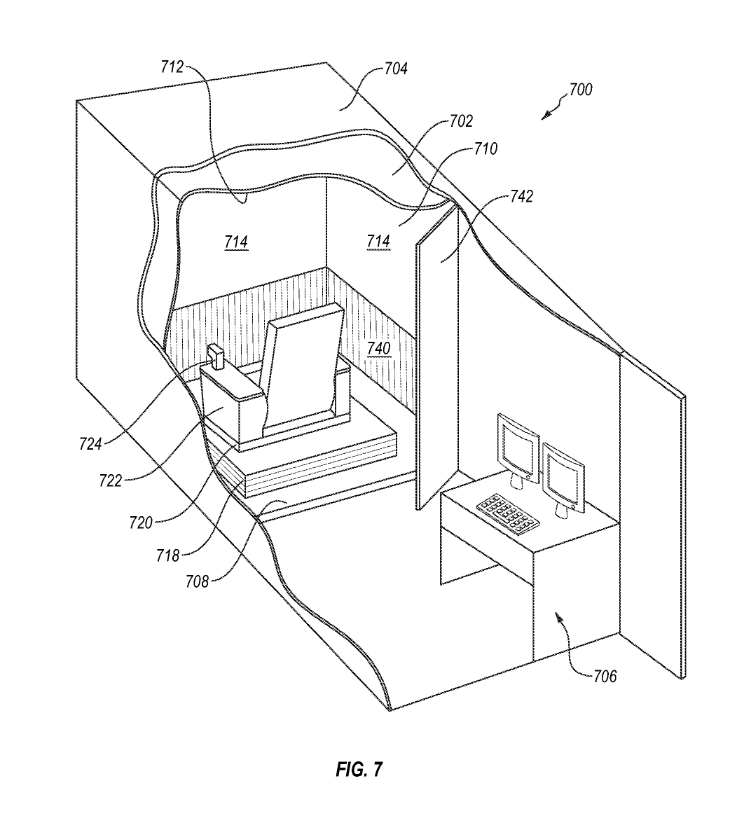

FIG. 7 illustrates a simulation training system 700 according to another components of the system 700. The system 700 can be in a transportable configuration, wherein the simulator housing 702 is substantially containerized or housed within a container 704, such as a shipping container. This allows the system 700 to be easily transported between locations and can be ideal when training space is not available indoors. Moreover, this can allow the system 700 to be setup and/or operated in wide variety of locations. For example, the system 700 can be operated with only a substantially flat surface (e.g., a concrete pad) and an adequate power source.

The container 704 can be constructed and configured to withstand extreme global mining environments. For example, the system 700 and/or container 704 can be constructed to include water and dust proofing and/or temperature, air, and/or noise controls to help ensure trainee and/or trainer comfort during training sessions. As discussed in more detail below, the system 700 can also include an air flow system and/or air conditioning unit(s) for providing enhanced comfort. In other embodiments, the system 700 can be in a free-standing configuration described below.

Optionally, the system 700 can further include a trainer station 706 for interfacing with a simulation and/or the trainee. For example, the system 700 can be configured to allow the trainer to observe, manage, and/or interact with a simulation within the simulator housing 702. The trainer station 706 can include a computer system having a dual-monitor interface that allows a trainer to observe a 3-D view, trigger events, review errors by a trainee, generate reports, administer scenarios, and/or perform other actions to improve the training experience. The trainer station 706 can be located inside or outside of the container 704 substantially adjacent to the simulator housing 702.

The simulator housing 702 may also include one or more movable doors 742 for allowing egress from and/or ingress into the simulator housing 702. The simulator housing 702 can be configured to substantially enclose one or more individuals within the simulation area of the simulator housing 702. Such a configuration can help block ambient light and/or shield the at least one display screen described below.

At least one display screen 714 may be provided in the simulator housing 702 for displaying simulated imagery. Such simulated imagery may include, but is not limited to, an interactive and/or virtual mining environment, equipment, machinery, a virtual representation of one or more individuals (e.g., a trainee, bystanders, workers, or the like), specific situational scenarios, occupational hazards, and/or other situations. The at least one display screen 714 may comprise four display screens 714, each located on a different wall 710 of the simulator housing 702. At least one of the display screens 714 may be located on the backside of the doors 742. The display screens 714 may be integral to the walls 710 and/or the doors 742. The display screens 714 may be attached or connected to the walls 710 and/or the doors 742. While four display screens 714 are described, it will be appreciated that the simulator housing 702 may include one, two, three, or any other appropriate number of display screens 714. For example, the simulator housing 702 may include one or more display screens 714 on the ceiling 712. In yet other embodiments, the display screens 714 may comprise a material with rear projection capability. Moreover, the display screens 714 may exhibit any suitable shape. For example, the one or more display screens 714 can comprise a cylindrical display, a curved display, a panel display, or any other suitable shape.

The display screens 714 may include one or more features configured to enhance the trainee's viewing and/or interactive experience. For example, the display screens 714 may be generally white, light grey, green, or any other suitable color. Further, the display screens 714 may include a screen gain configured to enhance perceived brightness of the simulated imagery projected on the at least one display screen. The display screens 714 may include one or more reflective materials such as, but not limited to, micro-reflective beads, silica, metallic materials (e.g., silver), reflective paint, or any other suitable material. Accordingly, as the simulated imagery is projected onto the display screens 714, the reflective materials can reflect that image's light toward the trainee such that the brightness of the simulated imagery appears to increase.

Optionally, the walls 710 may include one or more frame portions 740 that extend about at least a portion of the display screens 714. The frame portions 740 may include one or more non-reflective or light absorption materials configured to absorb light that may otherwise distort or degrade the projected imagery on the display screens 714. For example, the frame portions 740 may be black and the display screens 714 may be white. Thus, the frame portions 740 can provide a high contrast ratio between the display screens 714 and the frame portions 740.

A seating platform 718 can be selectively positioned in the simulator housing 702 so that the system is in a seated configuration. The seating platform 718 can allow a trainee to sit inside of the simulator housing 702 and to interact with a system. The seating platform 718 may be positioned in substantially a center of the floor 708. In other embodiments, the seating platform 718 may be positioned at other locations within the simulator housing 702. For example, the seating platform 718 may be positioned closer to one wall than another so as to more accurately simulate a real machine having off-center seating (e.g., an excavator).

As seen, the seating platform 718 may include a base 720, a seat 722 supported by the base 720, and/or one or more seated controls 724. The seated controls 724 can be supported by the base 720 and operated by a trainee in the seat 722. The one or more seated controls 724 may include one or more steering wheels, joysticks, buttons, knobs, pedals, levers, gear shifters, touch screens, keyboards, combinations thereof, or any other suitable controls. Because the seat 722 and the one or more seated controls 724 can be mounted on the base 720, the seating platform 718 can be easily installed and/or removed from the simulator housing 702. The seating platform 718 may exhibit any suitable configuration. For example, in the illustrated embodiment, the seating platform 718 may comprise a motion seating platform or motion platform providing movement in at least one degree of freedom to offer a more detailed motion feedback. This has the effect of allowing a trainee to experience rapid jolts, feelings of acceleration, fined-tuned sensitivity, and/or other forms of tactile feedback to more accurately simulate equipment operation.

The seating platform 718 may comprise a static seating platform that like the other seating platforms includes a plurality of seated controls but offers little or no feedback to the trainee. The seating platform 718 may comprise a vibrating seating platform for providing low cost basic haptic feedback. In other embodiments, the seating platform 718 may comprise a vibrating platform independently of the remainder of the seating platform 718. Further, the system may include a plurality of interchangeable seating platforms 718 and/or components thereof. For example, the system may include interchangeable seating platforms 718 and/or seated controls 724 allowing a range of different equipment (e.g., haul trucks, hydraulic shovels and excavators, rope shovels, track dozers, wheel loaders, draglines, light vehicles, graders, surface drills, roof bolters, continuous miners, longwalls, shuttle cars, and/or other suitable equipment) and/or different makes of equipment (e.g., CATERPILLAR, HITACHI, KOMATSU, LIEBHERR, and/or other makes) to be simulated by the system. This allows the system to simulate the functionality and/or operating environment of a wider range of real equipment with enhanced accuracy, increasing the versatility of the system.

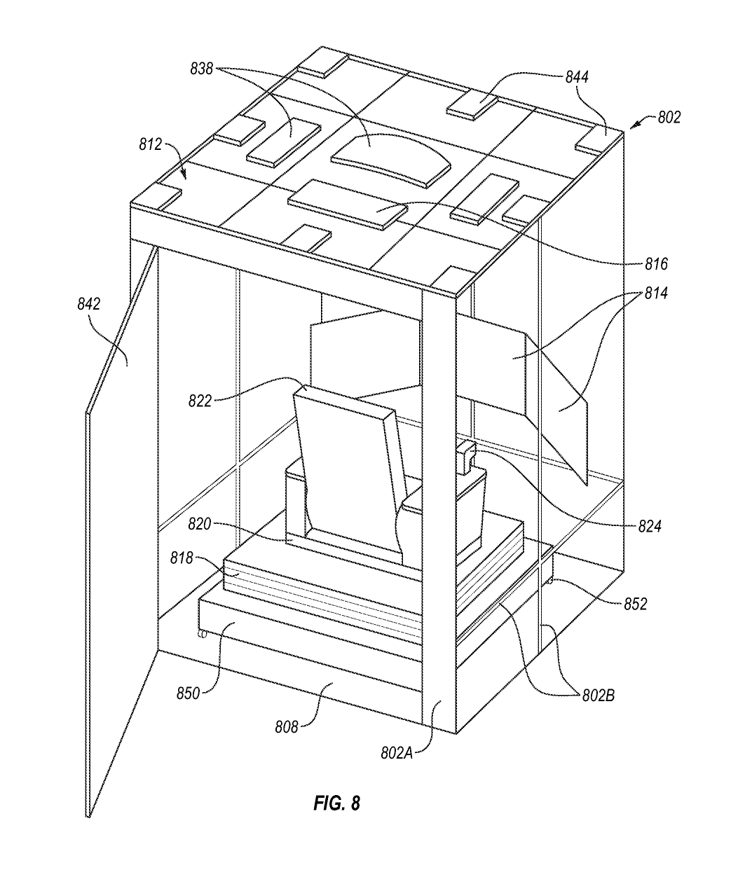

It will be appreciated that the simulator housing 702 can be constructed in any suitable manner. For instance, as shown in FIG. 8, the construction of a simulator housing 802 according to another embodiment can include one or more panel members 802A attached to a support frame 802B. The support frame 802B can include a plurality of tubular members that are connected or welded together. The panel members 802A may be attached to the tubular members to form the simulator housing 802.

FIG. 8 illustrates an embodiment of a simulator housing 802 that may be a standalone unit or used in conjunction with a container. The simulator housing 802 may include at least one display device comprising one or more projectors 838 for projecting the simulated imagery on at least one display screen 814.

The one or more projectors 838 may positioned in any suitable location within a simulator housing 802. The one or more projectors 838 can comprise four projectors 838 attached to the ceiling and positioned to display simulated imagery on the display screens 814 positioned on the walls of the simulator housing 802. The one or more projectors 838 may be positioned behind or inside of the at least one display screen 814. While the simulator housing 802 is described using at least one display screen and at least one display device comprising one or more projectors to display the simulated imagery, in other embodiments, the at least one display device can comprise light-emitting diode (LED) displays, pixel arrays, liquid crystal displays, televisions, display monitors, flat panel display devices, cathode ray tube (CRT) display devices, plasma display devices, combinations thereof, or any other suitable display device for displaying simulated imagery. The at least one display screen and the at least one display device can be integrated into a single unit or can be separate.

Optionally, the simulator housing 802 can include an air system and/or air conditioning unit(s) 816 configured to enhance comfort during training and/or assessment operations. The air conditioning unit 816 can be attached to the ceiling 812 or at any other suitable location within the simulator housing 802 to not inhibit use of the sensing devices 844 or visibility of the display screens 814.

A seating platform 818 may be connected to a seat 822 and seated controls 824 by a base 820. The seating platform 818 may be similar to the seating platform 718 described in FIG. 7.

In an embodiment, the seating platform 818 may include wheels 852 or may be positioned on a cart 850 including wheels 852 such that the seating platform 818 may be safely and/or conveniently wheeled into and out of the simulator housing 802. The cart 850 and/or the seating platform 818 may include one or features configured to lower the seating platform 818 into a platform hole described below and/or to lift the seating platform 818 from the platform hole.

The seating platform 818 may be configured to rest on the floor 808 or the seating platform may be configured to be removably secured to the floor 808. The seating platform 818 may be removably secured to the floor 808 via mechanical fasteners, one or more high friction mats, one or more magnets, a rail system, combinations thereof, or other suitable securement means.

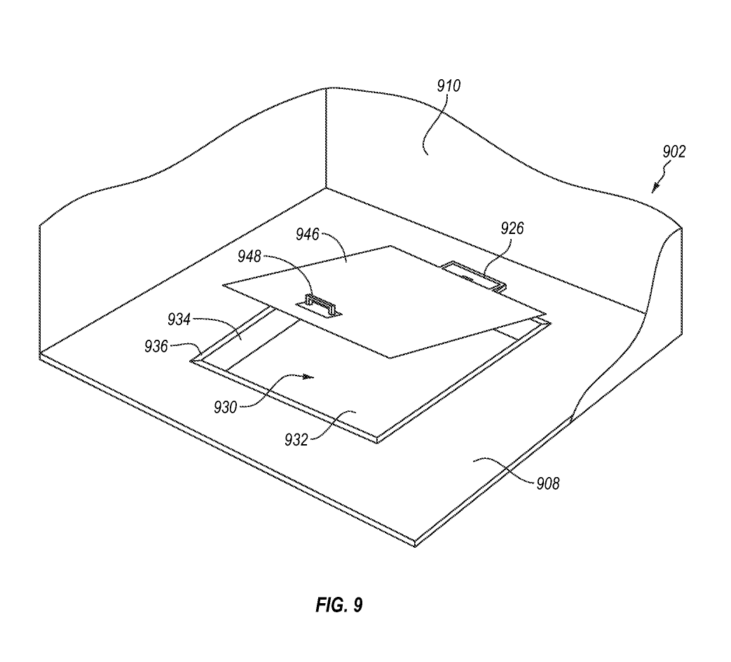

FIG. 9 is a partial cutaway view of a system housing 902 according to an embodiment. The system housing 902 can include one or more connection panels or patches 926 that facilitate one or more components of the system to interact with the computing system. The connection panel 926 may be disposed in the floor 908 and/or the walls 910 and a seating platform (e.g., seating platform 718) may be connectable to the connection panel 926 via one or more connectors or cables. One or more components of the seating platform may be connectable to the computer device of the system via a wireless connection. Such a configuration can allow many components of the different seating platforms to be shared and/or compatible with the system in a number of different configurations.

A seating platform (e.g., seating platform 718) may be at least partially recessed within the floor 908. The simulator housing 902 may include a platform hole 930 sized and configured to receive at least a portion of a base of the seating platform. In an embodiment, the platform hole 930 can be formed in the floor 908 of the simulator housing 902.

The platform hole 930 can include a bottom surface 932 and a plurality of side walls 934 extending between the bottom surface 932 and the floor 908. The platform hole 930 can further include a flange portion 936 extending from an upper end of the side walls 934 that overlaps at least a portion of the floor 908. The flange portion 936 can allow the platform hole 930 to be secured to the floor 908. One or more of the side walls 934 may be configured to reinforce the platform hole 930. For example, one or more portions of the side walls 934 may comprise metallic members that are fastened together. The bottom surface 932 may include one or more materials configured to help limit undesired vibration of the seating platform 918 within the platform hole 930. For example, the bottom surface 932 can include a rubber material, a softer plastic material, a foam material, a cellulose material, a softer metal material, combinations thereof, or any other suitable material.

The seating platform (such as seating platform 718 depicted in FIG. 7) and/or the platform hole 930 may be sized and configured such that the seating platform may simply rest in the platform hole 930. In other embodiments, the seating platform may be removably attached within the platform hole 930 via mechanical fasteners. For example, the seating platform may be fastened to a lower support surface of the platform hole 930 via one or more threaded holes and one or more screws or bolts.

The connection panel 926 may be located within the platform hole 930. Such a configuration allows the connection between the seating platform (e.g., the seated controls 724) to be concealed and/or hidden within the platform hole 930. Thus, the seating platform can allow a trainee to sit inside of the simulator housing 902 while comfortably and realistically interacting with the system.

The housing 902 can include a removable cover 946 for covering and/or filling the platform hole 930. Thus, the removable cover 946 can provide a substantially level surface and/or surface free of tripping hazards in the standing configuration. For example, when the removable cover 946 is positioned within the platform hole 930, an upper surface of the removable cover 946 may be substantially flush with an upper surface of the floor 908. Such a configuration allows one or more persons to stand or a freely walk about the simulator housing 902 without obstacles or tripping hazards on or in the floor 908.

The removable cover 946 may exhibit any suitable configuration. The removable cover 946 may have a peripheral shape generally corresponding to the platform hole 930. The removable cover 946 may include a rubberized upper surface. The removable cover 946 may include a wooden material, a honeycomb material, a composite material, a plastic material, a rubber material, combinations thereof, or any other suitable material.

Optionally, the removable cover 946 may include one or more handles 948 recessed or substantially flush with the upper surface of the removable cover 946. Thus, a user can utilize the handles 948 to more easily remove and/or install the removable cover 946 in the platform hole 930. In addition, the handles 948 can also assist a user in transporting the removable cover 946 into and out of the simulator housing 902.

As seen, the connection panel 926 may be located in the floor 908 between the platform hole 930 and the wall 910. This can allow the connection panel 926 to be accessible and usable in both the standing configuration and the seated configuration. For example, one or more user controls required in the standing configuration can utilize that same connection panel 926 used in the seated configuration. The user controls can interface or communicate with the computer device in both setup configurations.

It will be appreciated that the simulation training systems are to be regarded as exemplary only, as any appropriate simulation training systems are possible. For example, while the system 700 is shown in a transportable configuration, in other embodiments, exemplary embodiments of the simulation training system may be in a classroom or free-standing configuration, wherein the system is configured to be erected within an existing building or structure.

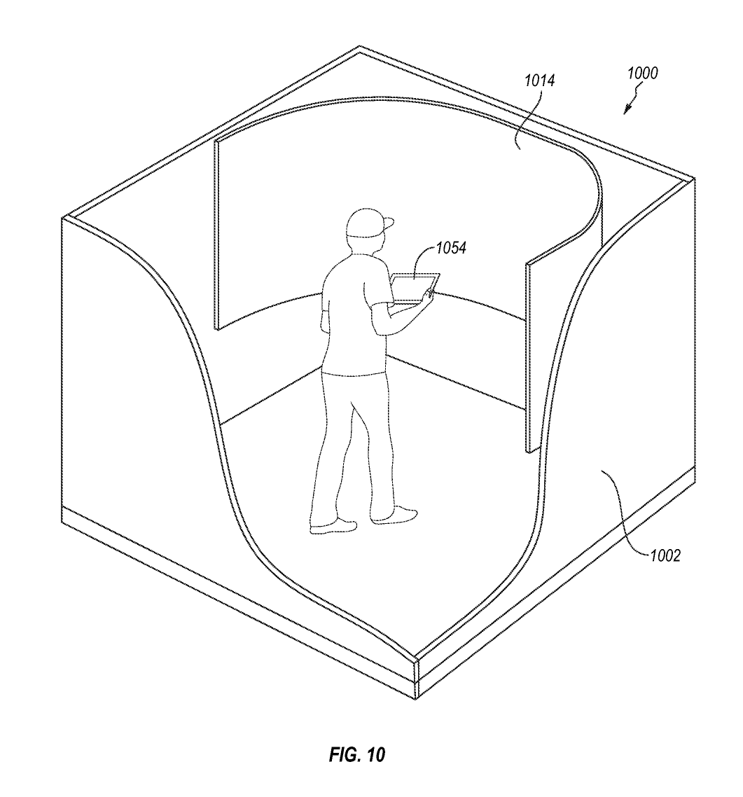

FIG. 10 illustrates a simulation training system 1000 in a free-standing configuration. As shown, the system 1000 may not include a floor. Instead, the system 1000 may utilize an existing floor within an existing building. In other embodiments, the system 1000 may include a floor. Like the system 700, the system 1000 is reconfigurable between the seated configuration and the standing configuration. In an embodiment, the simulation training system 1000 may utilize air conditioning and circulation from the structure it is enclosed within. The simulation training system 1000 may include its own airflow system to provide enhanced comfort during assessment and training operations.

Moreover, while the simulator housing is illustrated having a cube-like configuration, in other embodiments, the simulator housing may exhibit other suitable configurations. For example, the simulator housing may include a cylindrical display configuration. The simulator housing may include at least one generally cylindrical display screen, providing a continuous display surrounding the simulation area. Such a configuration may be useful where larger groups or people require a larger physical simulation environment. In other embodiments, a simulation training system 1000 may include a simulator housing 1002 having a curved display 1014 that is reconfigurable between the seated and standing configurations. Such a configuration may be effective for simulations where people require a high seating or standing position within the simulated environment or area, without artificial or simulated blind spots introduced by a faceted display.

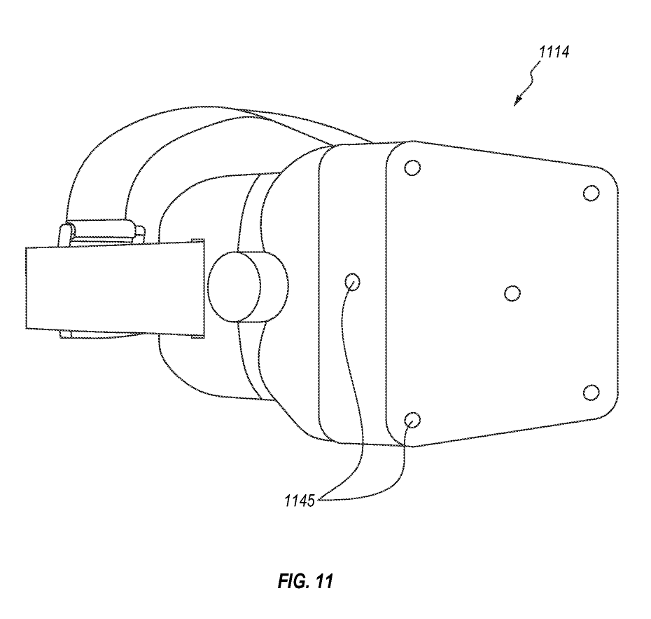

Exemplary embodiments of the simulation training system may comprise a head-mounted display unit 1114 as shown in FIG. 11. The head-mounted display unit 1114 may include visual and/or auditory displays to provide a trainee with a virtual environment. The head-mounted display 1114 can include one or more tracking points 1145 located on the head-mounted display unit 1114. The tracking points 1145 may be locations that a sensing device may track during use of a simulation training system to detect position and/or movement of a trainee. Such a configuration may be suitable for lower cost deployments, where a higher degree of immersion within the simulation environments is desired for a more effective training experience. The tracking points 1145 may be passive components, such as reflectors, points having differing color from a remainder of the head-mounting display unit 1114, and/or textured surfaces; or the tracking points 1145 may be active components, such as light emitting diodes, infra-red lights, radio-frequency transmitters, and/or other electro-magnetic signal transmitting devices.

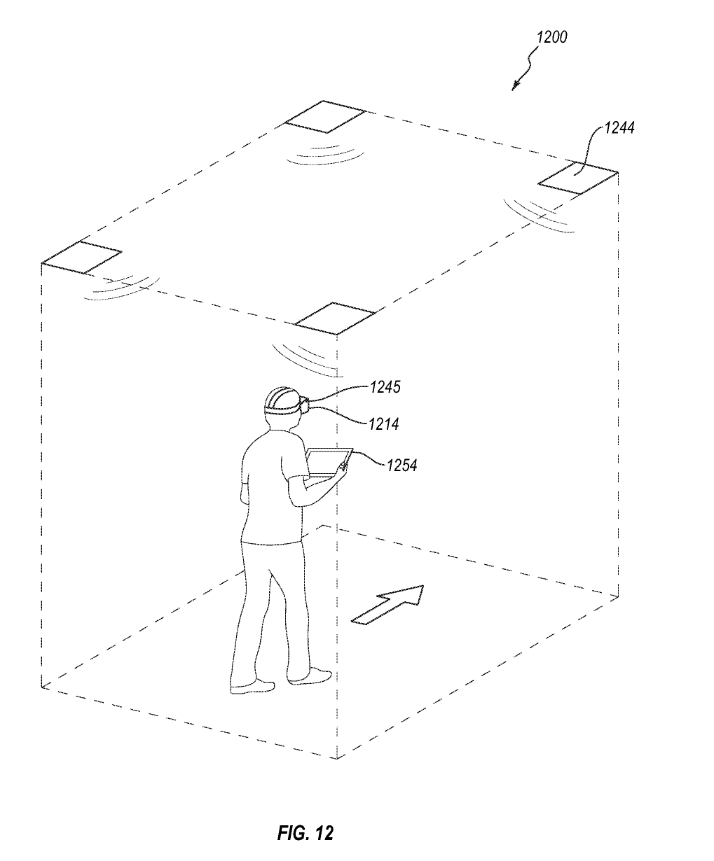

FIG. 12 depicts a trainee wearing a head-mounted display unit 1214 in a simulation training system 1200. The system 1200 can include a head-mounted display unit 1214 that creates a virtual environment relative to a trainee's position and perspective. The system 1200 can create a virtual environment by sensing the trainee's position using one of more sensing devices 1244 that sense the position and/or movement of the tracking points 1245 on the head-mounted display. The trainee can use hand-held controls 1254. When exposed to a virtual environment provided by the head-mounted display unit 1214 the trainee may not experience external stimuli. Therefore, the system 1200 may not include a simulator housing as depicted in other embodiments. Rather, one or more sensing devices 1244 may detect a position and/or movement of the head-mounted display unit 1214 and, therefore, the trainee in an open environment as depicted in FIG. 12. The sensing devices 1244 may be connected to walls or a ceiling of a room within a larger training facility, meeting room, office, or other multiple use room. For example, the system 1200 may allow for on-site training of miners in another room, such as a trailer or garage, at the mine location while still allowing use of the room for other uses when not needed for training.

The present disclosure may be embodied in other specific forms without departing from its spirit or essential characteristics. The described embodiments are to be considered in all respects only as illustrative and not restrictive. While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open-ended and have the same meaning as the word “comprising” and variants thereof (e.g., “comprise” and “comprises”).

1. A simulation training system comprising:
a simulator housing including one or more walls and at least one display screen on at least one of the one or more walls;
one or more display devices for displaying one or more interactive simulations on the at least one display screen;
one or more sensing devices arranged to sense a position and/or orientation of one or more parts of at least one person within or near the simulator housing; and
a motion processing module configured to process position and/or orientation data associated with the one or more parts of the at least one person and obtained from the one or more sensing devices.

2. The system of claim 1, further comprising a grading module configured to assess data collected by the motion processing module against a simulated environment.

3. The system of claim 1, further comprising a graphical control module configured to update and/or adjust the one or more interactive simulations based on a processed position and/or orientation data from the motion processing module.

4. The system of claim 1, wherein the one or more sensing devices are located within the simulator housing.

5. The system of claim 1, further comprising one or more hand-held controls configured to allow the at least one person to interact with the one or more interactive simulations in a standing configuration.

6. The system of claim 5, wherein the simulator housing includes a floor, a seating platform in or on the floor, and seated controls associated with the seating platform.

7. The system of claim 1, wherein the simulator housing is reconfigurable between a seated configuration, a seating platform having a seat and seated controls being positioned within the simulator housing such that the at least one person within the simulator housing may sit in the seat and interact with the one or more interactive simulations, and a standing configuration, wherein the seating platform is removed from the simulator housing such that the at least one person can stand or freely move within the simulator housing and interact with the one or more interactive simulations.

8. The system of claim 7, wherein the one or more interactive simulations comprise a first interactive simulation displayed on the at least one display screen in the seated configuration and a second interactive simulation displayed on the at least one display screen in the standing configuration, wherein the first interactive simulation is different than the second interactive simulation.

9. The system of claim 7, wherein the seating platform is configured to move in relation to the one or more interactive simulations.

10. The system of claim 7, wherein the simulator housing includes a floor, and wherein the floor includes a platform hole sized and configured to receive at least a portion of the seating platform when the simulator housing is in the seated configuration.

11. A method for updating an interactive simulation, the method comprising:
receiving one or more commands; and
based at least in part on the one or more commands, moving a virtual representation of a user within an interactive simulation generated by a simulation training system between a micro-movement mode, wherein a position of the virtual representation of the user within the simulation is updated to substantially match the position of the user within a simulator housing, and a macro-movement mode, wherein the position of the virtual representation of the user is updated within the interactive simulation to substantially match movement of the user in accordance with one or more movement schemes.

12. The method of claim 11, wherein at least one of the one or more commands comprise user input received by the simulation training system displaying the interactive simulation.

13. The method of claim 11, wherein at least one of the one or more commands are automatically generated by the simulation training system displaying the interactive simulation.

14. The method of claim 11, wherein the one or more movement schemes are selected by the user.

15. The method of claim 11, wherein the one or more movement schemes are automatically generated by the simulation training system.

16. The method of claim 11, wherein the one or more movement schemes comprises a movement scheme wherein a rate of movement of the virtual representation of the user within the virtual simulation is at least partially determined by a distance the user moves from an origin in a first direction.

17. The method of claim 16, wherein the origin is set in response to receiving a first input from the user.

18. The method of claim 17, wherein the first input comprises specific movements or gestures performed by the user within a simulator housing of the simulation training system.

19. The method of claim 17, wherein the first input comprises a toggle command entered by the user.

20. The method of claim 11, wherein the one or more movement schemes comprises a movement scheme wherein a rate of movement of the virtual representation of the user within the virtual simulation is at least partially determined by a distance the user leans relative to an origin.
